(19) United States
(12) Patent Application Publication
(10) Pub. No.: US 2008/0048529 A1
(43) Pub. Date: Feb. 28, 2008

(54) MANUFACTURING METHOD FOR STATOR CORE AND FOR STEPPING MOTOR, AND STEPPING MOTOR

(75) Inventor: Takeshi Shimoyama, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 11/831,472

(22) Filed: Jul. 31, 2007

(30) Foreign Application Priority Data
Jul. 31, 2006 (JP) JP2006-207418

(51) Int. Cl. H02K 37/00; H02K 15/02

(52) U.S. Cl. 310/49 R; 29/596

(57) ABSTRACT

A manufacturing method for a stator core of a stepping motor may include punching a metal plate made of magnetic material in a punching direction in a pole-teeth shape of the stator core by press working, and then, bending the pole-teeth shape of the stator core in an opposite direction to the punching direction to form a plurality of pole teeth which is erected from an inner circumferential edge of the stator core. Therefore, a burr is formed on the inner side of the pole teeth of the stator core, in other words, on an opposite side to a coil which is mounted on the stator core.

### CROSS REFERENCE TO RELATED APPLICATION

The present invention claims priority under 35 U.S.C. §119 to Japanese Application No. 2006-207418 filed Jul. 31, 2006, which is incorporated herein by reference.

### FIELD OF THE INVENTION

An embodiment of the present invention relates to a manufacturing method for a stator core for a stepping motor, to a manufacturing method for a stepping motor and to a stepping motor. More specifically, an embodiment of the present invention relates to a technique for press working for pole teeth that are erected and formed at an inner circumferential edge of a stator core.

### BACKGROUND OF THE INVENTION

A conventional PM type (Permanent Magnet Type) stepping motor 100 in which a permanent magnet is used in a rotor has been known as described, for example, in Japanese Patent Laid-Open No. 2004-112985. A schematic structure of the conventional stepping motor will be described as follows with reference to FIG. 7. In other words, a pair of inner stator cores 104 for two phases is superposed on each other in a back-to-back manner. A plurality of pole teeth 106 is formed upright or erected at an inner circumferential edge of the respective stator cores 104 at substantially equal intervals, and bobbin-less coils 110 which are covered with coating 108 made of insulating synthetic resin are respectively mounted on the outer periphery of the pole teeth 106.

A rotor 116 in which a magnet (permanent magnet) 114 is integrally fixed to a rotor shaft 112 is rotatably supported on an inner peripheral side of the pole teeth 106 of the inner stator cores 104 by mounting plates 120 through bearings 118. Outer stator cores 122 are assembled to the inner stator cores 104 and a plurality of pole teeth is formed at an inner circumferential edge of the respective outer stator cores 122 so as to be alternately disposed to the pole teeth 106 of the inner stator core 104.

In the stepping motor 100 structured as described above, coil ends 10a of the bobbin-less coils 110 are wound around terminal pins 102 provided in the respective inner stator cores 10. An electric current is supplied to the respective coils 110 through the terminal pins 102 and, as a result, a rotational drive force is applied to the rotor shaft 112 by generated magnetic field and rotation is outputted from one end side of the rotor shaft 112.

However, in the stepping motor 100 as described above, in order to form the pole teeth 106 by punching and bending by press working at an inner circumferential edge of the inner stator core 104, as shown in FIGS. 8(a) through 8(c), a metal plate for the inner stator core 104 is punched from its back side by a punch 124 along a contour of the pole teeth 106 which are to be formed at the inner circumferential edge of the inner stator core 104 (see FIG. 8(a)). Next, the pole teeth 106 are formed by being bent and erected from the backside of the inner stator core 104 by using a punch 126 (see FIG. 8(b)).

As a result, as shown in FIG. 8(c), a burr 128 may be formed at a tip end part or a peripheral edge part of each of the pole teeth 106 which are formed at the inner circumferential edge of the inner stator core 104 by punching of the punch 124. The burr 128 is formed to direct outside, i.e., in an outer direction from the outer peripheral edge side of the pole teeth 106 on which the bobbin-less coil 110 is mounted.

Accordingly, when the coil 110 is to be mounted on the inner stator core 104, the coil 110 may be damaged by the burr 128 that is formed on the pole teeth 106 by the press working and, as a result, a disconnection or an isolation voltage defect may occur. Further, even when the bobbin-less coil 110 is not used, in other words, even when a coil bobbin is used, a position of the coil bobbin may displace due to the burr 128 that is formed on the pole teeth 106 and thus a stable characteristic is not obtained.

Further, in order that the coil 110 is not brought into contact with the burr 128, the coil 110 is required to mount on the inner stator core 104 under a state that the coil 110 is maintained in a concentric state with the pole teeth 106 of the inner stator core 104. Therefore, workability is poor and a lot of time and labor are required. In addition, it is conceivable that, when the inner stator core 104 is to be formed, finish working such as abrasive blasting is performed to remove the burr 128. However, an additional work is required and thus cost increases.

### SUMMARY OF THE INVENTION

In view of the problems described above, an embodiment of the present invention may advantageously provide a manufacturing method for a stator core and for a stepping motor in which, for example, even when a bobbin-less coil is used as a coil, the bobbin-less coil is not damaged by a burr which is formed by press working on pole teeth that are formed at an inner circumferential edge of a stator core. Alternatively, an embodiment of the present invention may advantageously provide a stepping motor in which a bobbin-less coil is not damaged by a burr which is formed on the pole teeth of the stator core or in which positional displacement of the coil is prevented.

Thus, according to an embodiment of the present invention, there may be provided a manufacturing method for a stator core of a stepping motor which may comprise:

punching a metal plate made of magnetic material in a punching direction in a pole-teeth shape of the stator core by press working; and then

bending the pole-teeth shape of the stator core in an opposite direction to the punching direction to form a plurality of pole teeth which is erected from an inner circumferential edge of the stator core.

In accordance with an embodiment of the present invention, even when a burr or the like due to press working is formed on a plurality of pole teeth which is formed erected at an inner circumferential edge of a stator core, the burr or the like is formed on the inner side of the pole teeth of the stator core. Therefore, when a bobbin-less coil is to be mounted on the stator core, the bobbin-less coil is not damaged by the burr or the like and thus disconnection, isolation voltage defect or the like is prevented. Further, even when a coil bobbin is used, a problem such as positional displacement of the coil bobbin due to the burr or the like formed by press working is prevented.

In accordance with an embodiment, in the punching step, connecting parts connecting base ends of the pole teeth are punched at the same time of punching the pole-teeth shape of the stator core.

According to the manufacturing method described above, punching for the pole teeth and punching for the connecting parts connecting the base ends of the pole teeth are performed simultaneously. Therefore, a burr or the like which is formed on the connecting parts between the respective pole teeth is not formed on a placing face of the stator core on which the coil is mounted. Accordingly, even when a bobbin-less coil is to be mounted on the stator core, the bobbin-less coil is not damaged by the burr or the like and thus disconnection, isolation voltage defect or the like is prevented.

Further, according to an embodiment of the present invention, there may be provided a stepping motor including a rotor which comprises a rotor shaft and a magnet that is fixed to the rotor shaft, a stator having a stator core which is manufactured by the above-mentioned manufacturing method, and a coil which is mounted on the stator core around an outer periphery of its pole teeth.

According to the stepping motor as described above, even when a burr or the like is formed on the pole teeth which are formed to be erected at an inner circumferential edge of the stator core, and even when a coil mounted on the stator core is a bobbin-less coil, the bobbin-less coil is not damaged by the burr or the like and thus disconnection, isolation voltage defect or the like is prevented. Further, even when a coil bobbin is used, a problem such as positional displacement of the coil bobbin due to the burr or the like formed by press working is prevented and thus assembling workability when the coil is to be mounted on the stator core is satisfactory. As a result, a stepping motor with a stable quality is obtained and product yield is improved.

In the embodiment described above, it is effective when the bobbin-less coil is mounted on the stator core in a non-contact state with the pole teeth. When the bobbin-less coil is mounted in a non-contact state with the pole teeth of the stator core as described above, contact of the bobbin-less coil with the pole teeth is surely prevented and thus a short circuit due to contact does not occur.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a sectional view showing a structure of a stepping motor in accordance with an embodiment of the present invention.

FIG. 2(a) is a perspective view showing a stator core in accordance with an embodiment of the present invention and FIG. 2(b) is an enlarged view showing a tip end shape of one of pole teeth in detail.

FIGS. 3(a) and 3(b) are explanatory schematic views showing manufacturing steps for a stator core of the stepping motor shown in FIG. 1.

FIGS. 4(a) and 4(b) are explanatory views schematically showing a formed direction of a burr when a stator core is manufactured by the manufacturing method shown in FIGS. 3(a) and 3(b).

FIGS. 5(a) through 5(c) are views showing steps of mounting a bobbin-less coil on a stator core in accordance with an embodiment of the present invention.

FIGS. 6(a) and 6(b) are explanatory schematic views showing manufacturing steps for another stator core in accordance with an embodiment of the present invention.

FIG. 7 is a sectional view showing a schematic structure of a conventional stepping motor.

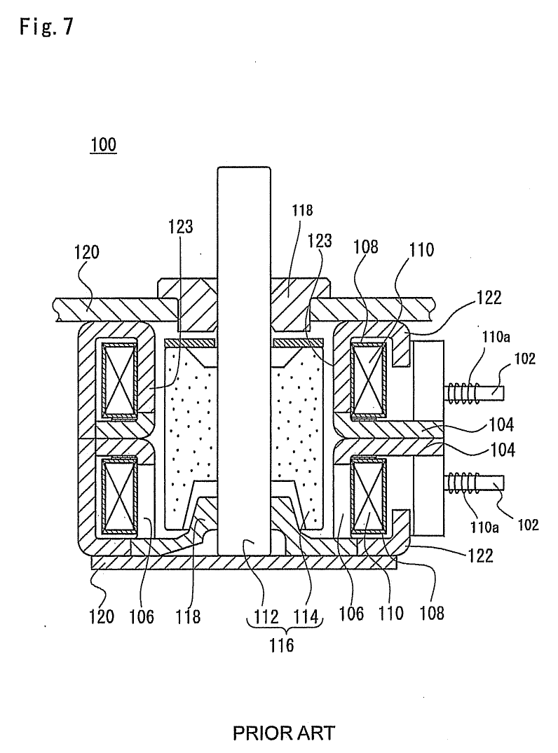

FIGS. 8(a) through 8(c) are explanatory views showing manufacturing steps for a stator core of the conventional stepping motor shown in FIG. 7.

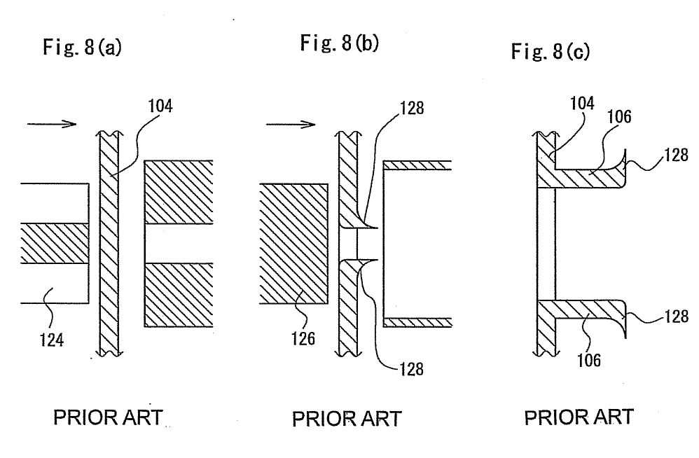

### DETAILED DESCRIPTION OF THE PREFERRED EMBODIMENTS

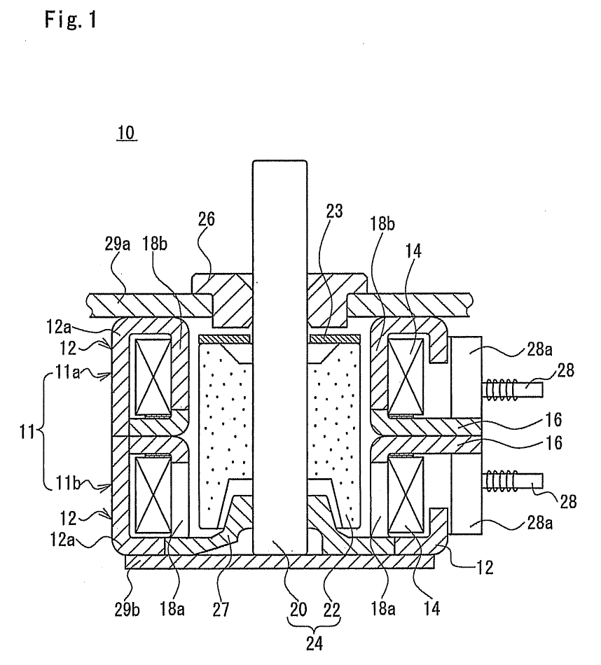

A stepping motor in accordance with an embodiment of the present invention will be described in detail below with reference to the accompanying drawings. FIG. 1 is a cross-sectional view showing a schematic structure of a stepping motor 10 in accordance with an embodiment of the present invention.

The stepping motor 10 in this embodiment includes, as shown in the drawing, a rotor 24 provided with a rotor shaft 20 and a cylindrical magnet 22 (permanent magnet) which is fixed to an outer peripheral face of the rotor shaft 20 and a stator 11 which is disposed so as to surround the rotor 24.

The stator 11 is structured in a two-phase structure with a first stator assembly 11a and a second stator assembly 11b which is fixed to the first stator assembly 11a in a back-to-back manner. In this embodiment, since basic structures of the first stator assembly 11 a and the second stator assembly 11b are the same, the same notational symbols are used to their common portions.

The first stator assembly 11a and the second stator assembly 11b are respectively structured of the inner stator core 16, the outer stator core 12 and a bobbin-less coil 14 which is not provided with a coil bobbin.

The bobbin-less coil 14 is mounted on the inner stator core 16 and a pair of the inner stator cores 16 is superposed on each other in a back-to-back manner. A plurality of pole teeth 18a is circumferentially formed upright at an inner circumferential edge of the respective inner stator cores 16 at substantially equal intervals. The outer stator cores 12 are respectively assembled to the inner stator cores 16. Similarly to the inner stator core 16, a plurality of pole teeth 18b is circumferentially formed upright at an inner circumferential edge of the respective outer stator cores 12. The pole teeth 18a of the inner stator core 16 and the pole teeth 18b of the outer stator core 12 are disposed in an alternately adjacent manner in a circumferential direction.

The bobbin-less coil 14 is mounted on the inner stator core 16 so that an inner peripheral face of the bobbin-less coil 14 faces an outer peripheral face of the pole teeth 18a of the inner stator core 16 and the pole teeth 18b of the outer stator core 12.

The rotor 24 including the magnet 22 integrally provided around the rotor shaft 20 is disposed in a center portion of the stator 11 as structured above through a specified clearance.

A mounting plate 29a which is, for example, utilized as a fixing plate when the stepping motor 10 is mounted on an apparatus is fixed to the outer stator core 12 of the first stator assembly 11a. The mounting plate 29a is fixed with a first radial bearing 26a which rotatably supports the rotor shaft 20 on an output side.

A second radial bearing 27 which rotatably supports the rotor shaft 20 on an opposite-to-output side is fixed to the outer stator core 12 of the second stator assembly 11b. In addition, a side plate 29b is fixed to the outer stator core 12 of the second stator assembly 11b and a shaft end of the rotor shaft 20 is rotatably supported in a thrust direction by the side plate 29b.

In other words, the rotor 24 is rotatably supported by the first radial bearing 26, the second radial bearing 27 and the side plate 29b. Further, one end portion of the rotor shaft 20 of the rotor 24 is protruded on an outer side (output side) from the outer stator core 12 of the first stator assembly 11a to be formed as an output shaft for rotational drive.

A washer 23 made of resin is disposed between the first radial bearing 26 and the magnet 22 to regulate movement of the rotor 24 to the output side.

Terminal blocks 28a which support the terminal pins 28 for supplying electric power to the respective bobbin-less coils 14 are fixed to the respective inner stator cores 16. An alternating current is supplied to the bobbin-less coils 14 through the terminal pins 28 and rotating magnetic field is generated. Magnetic rotary force is applied to the magnet 22 of the rotor 24 by the rotating magnetic field and thus the rotor shaft 20 is rotationally driven together with the magnet 22.

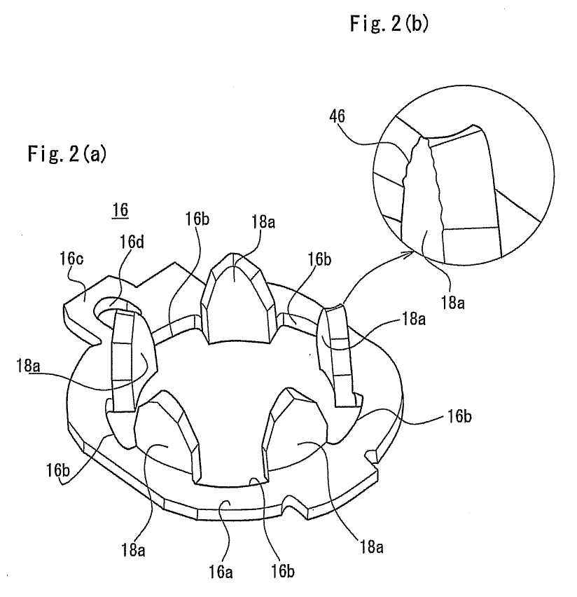

FIG. 2(a) is a perspective view showing an outward appearance of the inner stator core 16. As shown in FIG. 2(a), in this embodiment, an outer peripheral edge of a circular ring-shaped base portion 16a of the inner stator core 16 on which the bobbin-less coil 14 is placed is formed in a roughly circular shape. A plurality of pole teeth 18a is formed and erected at an inner circumferential edge of the base portion 16a of the inner stator core 16 through connecting parts 16b at substantially equal intervals.

A terminal block mounting part 16c for mounting a terminal block 28a which holds terminal pins 28 is formed on an outer peripheral edge of the base portion 16a. Further, the terminal block mounting part 16c is provided with a positioning hole 16d which is used to position or align a pair of inner stator cores 16 that are superposed on each other in a back-to-back manner.

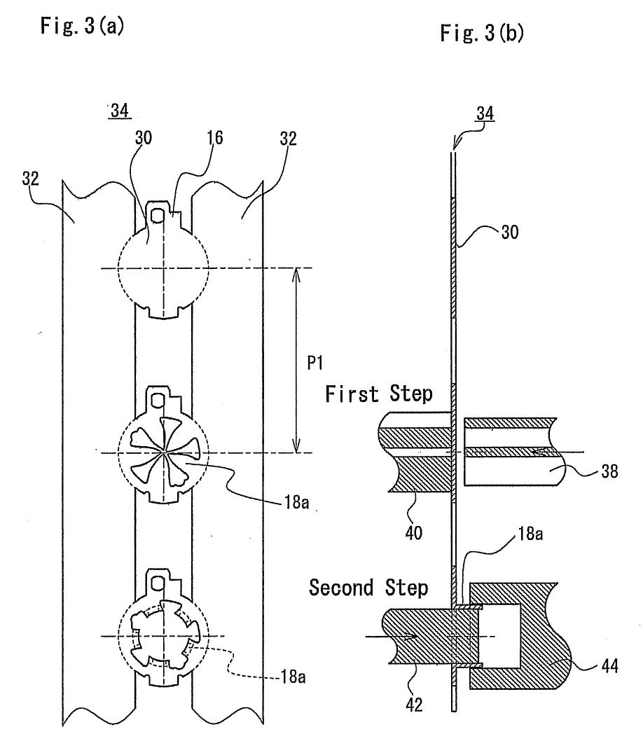

The inner stator core 16 having the structure as described above is manufactured by press working. The manufacturing steps will be described below with reference to FIGS. 3(a) and 3(b).

First, as shown in FIG. 3(a), a band plate member 34 in which core forming parts 30 in a roughly circular shape which correspond to an outer diameter of the inner stator core 16 are connected with lead parts 32 which are provided on both sides of the core forming part 30 in a substantially parallel manner is successively fed through a progressive press die with a specified feed pitch P1. The band plate member is formed of a plate member made of magnetic metal such as iron.

Further, as shown in FIG. 3(b), in a first step, a punch 38 having a shape corresponding to a contour of the pole teeth 18a is disposed on one side (front face side) of the core forming part 30 of the band plate member 34 and a punching base 40 is disposed on the opposite side (back face side) at a position corresponding to the punch 38. The band plate member 34 is pressed and punched by the punch 38 from the front face side to the back face side to form a shape profile of the pole teeth 18a.

In this manner, a plurality of the pole teeth 18a having a tapering shape is formed from an outer circumferential side to a center side at a specified interval (see FIG. 3(a)). In this embodiment, a circular ring portion which connects the pole teeth 18a with each other and on which the bobbin-less coil 14 is placed is referred to as a base portion 16a. Further, a circular arc-shaped edge portion between adjacent pieces of the pole teeth 18a which are formed at an inner circumferential edge of the base portion 16a is referred to as a connecting part 16b.

In a second step, base portions of the pole teeth 18a which have been punched in the first step are bent upright by press working to form erected pole teeth 18a. In this second step, a bending punch 42 is disposed on the side (back face side) where the punching base 40 is disposed in the first step, and a bending base 44 is disposed on the side (front face side) where the punch 38 is disposed. The pole teeth 18a is pressed and bent by the bending punch 42 and thus the pole teeth 18a are erected on the front face side.

After these steps have been performed, the lead parts 32 which are formed on both sides of the inner stator core 16 that is provided with the pole teeth 18a are cut off and separated from the band plate member 34. As a result, the inner stator core 16 is obtained in which the pole teeth 18a are integrally formed at the inner circumferential edge portion of the base portion 16a.

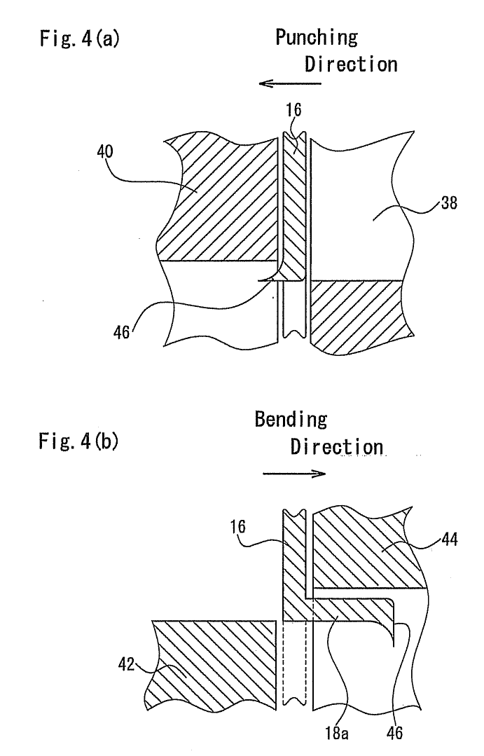

FIGS. 4(a) and 4(b) are explanatory views showing a direction of a burr which is formed when the pole teeth 18a are punched and then erected as described above. In this embodiment, as shown in FIG. 4(a), the inner stator core 16 may be formed with a burr 46 or the like in the first step shown in FIGS. 3(a) and 3(b). However, the burr 46 is formed on the back face side of a cutting face of the pole teeth 18a and connecting parts 16b, in other words, on an edge portion of the side where the punching base 40 is disposed. Further, as shown in FIG. 4(b), the pole teeth 18a which are punched as described above are pressed by the bending punch 42 from the back face side, i.e., in an opposite direction to the punching direction and thus the pole teeth 18a are erected or formed upright on the front face side. Therefore, as shown with the enlarged view in FIG. 2(b) and in FIG. 4(b), the burr 46 or the like formed on a cutting end face is disposed on the inner peripheral side of the cutting end face of the pole teeth 18a and on a back face side of the cutting end face of the connecting part 16b. Therefore, the burr 46 or the like is not formed on the face where the bobbin-less coil 14 is disposed.

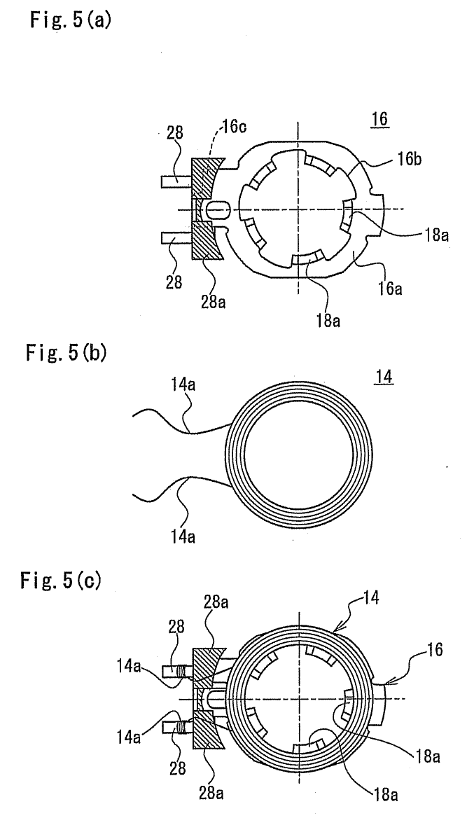

A terminal block 28a which holds terminal pins 28 is integrally mounted on the inner stator core 16 which is manufactured as described above (see FIG. 5(a)). The terminal block 28a is formed of synthetic resin material having heat resistance and insulation property such as liquid crystal polymer or the like. The terminal block 28a is mounted on a terminal block mounting part 16c which is formed on one side of the inner stator core 16 by insert-molding or the like. Terminal pins 28 for supplying electric power to the bobbin-less coil 14 are fixed to the terminal block 28a.

On the other hand, the bobbin-less coil 14 which is to be mounted on an outer periphery of a plurality of pole teeth 18a of the inner stator core 16 is formed (see FIG. 5(b)). Self fused layer is provided on a surface of a coil wire which is used to form the bobbin-less coil 14 and thus a shape of the bobbin-less coil 14 is maintained without a coil bobbin.

The bobbin-less coil 14 shown in FIG. 5(b) which is formed as described above is mounted on the outer periphery of the pole teeth 18a of the inner stator core 16 shown in FIG. 5(a) (see FIG. 5(c)). In this case, when an adhesive member such as an adhesive tape is provided at a contact face of the bobbin-less coil 14 with the inner stator core 16, in other words, when an adhesive member is interposed between the bobbin-less coil 14 and the base portion 16a of the inner stator core 16, the bobbin-less coil 14 is fixed to the inner stator core 16.

The adhesive member is preferably formed of resin material having insulation property.

In addition, it is preferable that a small clearance is provided between the inner peripheral face of the bobbin-less coil 14 and the outer peripheral faces of the pole teeth 18a of the inner stator core 16. In other words, the bobbin-less coil 14 may be mounted on the inner stator core 16 in a non-contact state with the pole teeth 18a of the inner stator core 16. When the bobbin-less coil 14 is mounted on the inner stator core 16 as described above, contact of the bobbin-less coil 14 with the pole teeth 18a is surely prevented and thus a short circuit due to contact does not occur.

After the coil ends 14a of the bobbin-less coil 14 have wound around the terminal pins 28, the coil ends 14a are soldered with the terminal pins 28. As a result, electric power can be supplied to the bobbin-less coil 14 through the terminal pins 28.

As described above, when the bobbin-less coil 14 is to be mounted on the inner stator core 16, the burr 46 or the like which is formed at the time of punching by press working is formed at a peripheral edge of the face on the side which does not abut with the bobbin-less coil 14. Therefore, the burr 46 or the like which is formed on cutting end faces of the pole teeth 18a and the connecting parts 16b does not abut with the bobbin-less coil 14 to cause the bobbin-less coil 14 to damage. Accordingly, malfunction such as disconnection or isolation voltage defect of the bobbin-less coil 14 does not occur. Further, when the bobbin-less coil 14 is to be mounted on the inner stator core 16, the bobbin-less coil 14 is not damaged by the burr 46 or the like and thus assembling workability is satisfactory, quality of the stepping motor 10 is stable, and product yield is improved.

A pair of the inner stator cores 16 on which the bobbin-less coils 14 are mounted as described above and in which the pole teeth 18a are erected in opposite directions to each other are superposed on each other in a back-to-back manner so that they do not displace from each other through the positioning holes 16d. After that, for example, outer peripheral end faces of the inner stator cores 16 are welded and the inner stator cores 16 are fixed to each other.

After that, a pair of the outer stator cores 12 are assembled to the inner stator cores 16 which are fixed to each other for two phases as described above. An outer peripheral face of the outer stator core 12 is formed to substantially cover the outer peripheral face of the coil 14 and, in this embodiment, the outer peripheral face of the outer stator core 12 is formed as a motor case. Further, the pole teeth 18b are provided on an inner peripheral face of the outer stator core 12. The pole teeth 18b of the outer stator core 12 are alternately and adjacently disposed at positions corresponding to spaces of the pole teeth 18a of the inner stator core 16.

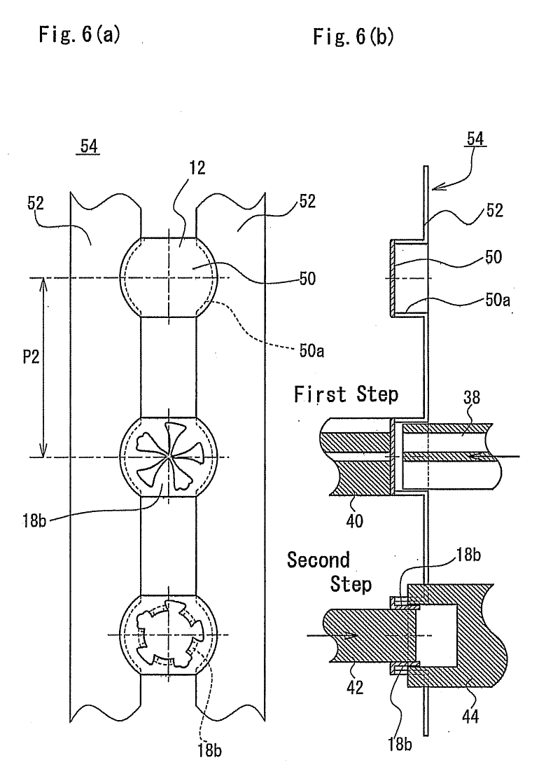

The pole teeth 18b which are formed on the inner peripheral face of the outer stator core 12 are structured similarly to the pole teeth 18a which are formed in the inner stator core 16 such that the pole teeth 18b are punched from one face side and then bent and erected from the other opposite face side. Manufacturing steps for the outer stator core 12 will be described below with reference to FIGS. 6(a) and 6(b).

First, a case forming part 50 in a roughly circular shape which corresponds to an outer diameter of the outer stator core 12 is formed in a long size member 54 which is formed of a plate member made of magnetic metal such as iron. The case forming parts 50 of the long size member 54 are connected with tape parts 52 which are formed in a substantially parallel manner on both sides of the case forming parts 50. The long size member 54 is successively fed through a progressive press die with a feed pitch P2. In this embodiment, the case forming part 50 and the tape part 52 are connected with wall parts 50a which are formed on both sides of the case forming part 50. The wall parts 50a become to be side walls of the outer stator core, i.e., the motor case 12a (see FIG. 1) when the outer stator core 12 has been separated.

Further, in a first step, a punch 38 having a shape corresponding to a contour of the pole teeth 18b is disposed on one side (inner face side) of the case forming part 50 of the long size member 54 and a punching base 40 is disposed on the opposite side (outer face side) at a position corresponding to the punch 38. The long size member 54 is pressed and punched by the punch 38 from the inner face side to the outer face side to form a shape profile of the pole teeth 18b. In this manner, a plurality of the pole teeth 18b having a tapering shape is formed from an outer peripheral side to a center side at a specified interval (see FIG. 6(a)).

In a second step, base portions of the pole teeth 18b which are punched in the first step are bent upright by press working to form erected pole teeth 18b. In this second step, a bending punch 42 is disposed on the side (outer face side) where the punching base 40 is disposed in the first step, and a bending base 44 is disposed on the side (inner face side) where the punch 38 is disposed. The pole teeth 18b is pressed and bent by the bending punch 42 and thus the pole teeth 18b are erected on the inner face side.

After that, the outer stator core 12 which is formed with the pole teeth 18b is cut off from the tape parts 52 to obtain the outer stator core 12. According to the outer stator core 12 which is formed as described above, similarly to the inner stator core 16, the burr 46 or the like which is formed by punch working is disposed on the face which does not face the bobbin-less coil 14. Therefore, the cutting edge portion of the contacting face side with the bobbin-less coil 14 is not formed with the burr 46 or the like and thus the bobbin-less coil 14 is prevented from being damaged.

The rotor 24 having the magnet 22 fixed to the rotor shaft 20 is disposed on the inner peripheral side of the pole teeth 18a of the inner stator core 16 and the pole teeth 18b of the outer stator core 12 to manufacture the stepping motor 10.

The present invention has been described in detail using the embodiments, but the present invention is not limited to the embodiments described above and many modifications can be made without departing from the present invention.

For example, in the embodiment described above, the bobbin-less coil 14 is firstly mounted on the outer periphery of the pole teeth 18a of the inner stator core 16 but the bobbin-less coil 14 may be firstly mounted on the outer periphery of the pole teeth 18b of the outer stator core 12. Further, in the embodiment described above, the bobbin-less coil 14 is used. However, even when a coil with a coil bobbin is used, the burr formed in the pole teeth of the stator core may cause positional displacement of the coil with the coil bobbin. Therefore, the present invention may be applied to a case when a coil bobbin is used.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A manufacturing method for a stator core of a stepping motor comprising:
punching a metal plate made of magnetic material in a punching direction in a pole-teeth shape of the stator core by press working; and then
bending the pole-teeth shape of the stator core in an opposite direction to the punching direction to form a plurality of pole teeth which is erected from an inner circumferential edge of the stator core.

2. The manufacturing method for a stator core of a stepping motor according to claim 1, wherein in the step of the punching, connecting parts connecting base ends of the pole teeth are punched at the same time when the pole-teeth shape is punched.

3. The manufacturing method for a stator core of a stepping motor according to claim 1, further comprising:
forming a wall part which is going to be a motor case and is protruded in the metal plate before the step of the punching;
wherein the punching direction is the same direction as a protruded direction of the wall part, and a bending direction of the pole-teeth shape is an opposite direction to the protruded direction of the wall part.

4. A manufacturing method for a stepping motor comprising:
manufacturing a stator core having a plurality of pole teeth at an inner circumferential edge comprising:
punching a metal plate made of magnetic material in a punching direction in a shape corresponding to a contour of a plurality of pole teeth; and
forming a portion corresponding to the contour of a plurality of pole teeth formed in the punching a metal plate step that is bent in an opposite direction to the punching direction to form the plurality of the pole teeth; and
,mounting a coil on the stator core around an outer periphery of the plurality of the pole teeth.

5. The manufacturing method for a stepping motor according to claim 4, wherein the coil is a bobbin-less coil which is structured of a wire having self fused layer on a surface of the wire, and the bobbin-less coil is mounted on the stator core around the outer periphery of the plurality of pole teeth without using a coil bobbin.

6. The manufacturing method for a stepping motor according to claim 5, further comprising:
adhesively fixing the bobbin-less coil to the stator core through an adhesive member.

7. The manufacturing method for a stepping motor according to claim 4, wherein
the stator core comprises an inner stator core and an outer stator core which are assembled to each other so as to dispose the coil therebetween, and
the inner stator core and the outer stator core are respectively provided with the plurality of the pole teeth which is formed through the punching a metal plate step and the forming a portion step.

8. A stepping motor comprising:
a rotor which comprises a rotor shaft and a magnet that is fixed to the rotor shaft;
a stator which comprises a stator core which is provided with a plurality of pole teeth facing the magnet at an inner circumferential edge of the stator core; and
a coil which is mounted on the stator core around an outer periphery of the pole teeth;
wherein the pole teeth formed at the inner circumferential edge of the stator core is formed with a metal plate made of magnetic material and which is punched in a punching direction by press working and bent in an opposite direction to the punching direction.

9. The stepping motor according to claim 8, wherein the coil is mounted on the stator core in a non-contact state with the pole teeth.

10. The stepping motor according to claim 8, wherein the coil is a bobbin-less coil which is structured of a wire having self fused layer on a surface of the wire, and the bobbin-less coil is mounted on the stator core around the outer periphery of the plurality of the pole teeth without using a coil bobbin.

11. The stepping motor according to claim 8, wherein
the stator core comprises a pair of inner stator cores which are superposed on each other in back-to-back manner and outer stator cores which are respectively assembled to the pair of the inner stator cores, and
the pole teeth of the inner stator core and the pole teeth of the outer stator core are alternately disposed in a circumferential direction.
